(19) United States
(12) Patent Application Publication
(10) Pub. No.: US 2009/0247262 A1
(43) Pub. Date: Oct. 1, 2009

(54) SLOT MACHINE AND CONTROL METHOD THEREOF

(75) Inventor: Yoichi KATO, Koto-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/206,460

(22) Filed: Sep. 8, 2008

Related U.S. Application Data
(60) Provisional application No. 61/039,297, filed on Mar. 25, 2008.

(51) Int. Cl. A63F 9/24; A63F 13/00

(52) U.S. Cl. 463/20

(57) ABSTRACT

A slot machine executes a slot game in a following manner. First, the slot machine receives an external input, then rearranges symbols arranged in a display region, and awards a winning if a predetermined number of symbols of a predetermined type are displayed. In the rearrangement of the symbols, if the amount of bet received by the bet switch is minimum, a display is controlled so that a minimum number of columns within symbol display regions are displayed as targeted-symbol display regions being targeted for counting the number of symbols of a predetermined type. Accordingly, the slot machine can produce such an effect that a larger amount of bet will lead to a more advantageous award, and thus can attract players' interests concerning betting actions, thereby improving entertainment properties.

### CROSS-REFERENCE TO RELATED APPLICATION

This application is based upon and claims the benefit of U.S. Provisional Application No. 61/039,297, filed on Mar. 25, 2008; the entire contents of which are incorporated herein by reference.

### BACKGROUND OF THE INVENTION

1. Field of the Invention

The present invention relates to a slot machine and a control method thereof with which a player plays a game by using medals, coins, bills and the like.

2. Description of Related Art

U.S. Pat. No. 7,309,282 and U.S. Pat. No. 7,311,602 B2 disclose related slot machines. Such a conventional slot machine is configured to: start to rotate multiple reels when a player operates a spin switch after inserting medals, coins or bills into an insertion slot of the slot machine and making a bet of credits by using a BET switch; and then sequentially stop rotating the reels.

A side face of each of the reels is provided with a reel band on which multiple symbols are printed, and the multiple symbols are displayed on display region provided on a front face of a cabinet when all the reels stop rotation. Then, a winning award according to the bet is provided when multiple symbols form a specific combination.

Such conventional slot machine is simply configured to provide a winning award according to a bet when multiple symbols forms a specific combination and is therefore apt to render games monotonous. Accordingly, there has been a demand for providing a slot machine that offers more excitement to players.

### SUMMARY OF THE INVENTION

A first aspect of the present invention provides a slot machine including: (a) a display provided with display regions to arrange and display multiple symbols on multiple columns; (b) a bet switch configured to receive a bet from a player; and (c) a controller operable to: (A) execute a slot game upon receipt of an external input, rearranging the symbols arranged in the display regions, and award a winning if a predetermined number of symbols of a predetermined type are displayed; and (B) when rearranging the symbols if the bet switch receives a minimum bet amount, control the display so that a predetermined minimum number of columns within the symbol display regions are displayed as targeted-symbol display regions being targeted for counting a number of symbols of the predetermined type.

A second aspect of the present invention provides a slot machine including: (a) multiple rotatable reels each provided with multiple symbols on a side surface; (b) a display disposed on a front face side of the reels and provided with an image display region including display region to display the symbols on each of the reels; (c) a bet switch configured to receive a bet from a player; and (d) a controller operable to: (A) execute a slot game upon receipt of an external input, rearranging the symbols arranged in the display regions by rotating and stopping the reels, and awarding a winning if a predetermined number of symbols of a predetermined type are displayed; and (B) when rearranging the symbols if the bet switch receives a minimum bet amount, control the display so that a predetermined minimum number of columns within the symbol display regions are displayed as targeted-symbol display regions being targeted for counting a number of symbols of the predetermined type.

A third aspect of the present invention provides a method of controlling a slot machine which includes the steps of: (a) causing a bet switch to receive a bet from a player; (b) causing a controller to rotate multiple reels each provided with multiple symbols on a side surface; (c) along with rotation of the reels, causing the controller to display an image on a display which is disposed at front face sides of the reels and includes an image display region having a symbol display region for displaying the symbols on the plurality of reels, so that a predetermined minimum number of columns within the symbol display regions are displayed as targeted-symbol display regions if the bet switch receives a minimum bet amount, the targeted-symbol display regions being targeted for counting a number of symbols of the predetermined type; (d) causing the controller to stop the rotating reels; and (e) causing the controller to award a winning if a predetermined number of symbols of a predetermined type are displayed.

### BRIEF DESCRIPTION OF THE DRAWINGS

FIG. 1A is a view for explaining an example of symbols to be displayed on a display of a slot machine according to an embodiment of the present invention.

FIG. 1B is a view for explaining award relevant to the symbols displayed on the display of the slot machine according to the embodiment.

FIG. 2A is another view for explaining an example of the symbols to be displayed on the display of the slot machine according to the embodiment.

FIG. 2B is another view for explaining the award relevant to the symbols displayed on the display of the slot machine according to the embodiment.

FIG. 3A is another view for explaining an example of the symbols to be displayed on the display of the slot machine according to the embodiment.

FIG. 3B is another view for explaining the award relevant to the symbols displayed on the display of the slot machine according to the embodiment.

FIG. 4A is a view for explaining an example of displayed symbols in the case of a minimum bet to be displayed on the display of the slot machine according to the embodiment.

FIG. 4B is a view for explaining another example of the displayed symbols in the case of the minimum bet to be displayed on the display of the slot machine according to the embodiment.

FIG. 5 is a view showing an overall configuration of a slot machine according to the embodiment.

FIG. 6 is a block diagram showing an internal configuration of the slot machine according to the embodiment.

FIG. 7 is a view showing display region to be set up on a display of the slot machine according to the embodiment.

FIG. 8 is a flowchart showing a slot game execution process by the slot machine according to the embodiment.

FIG. 9 is a flowchart showing an image effect control process by the slot machine according to the embodiment.

FIG. 10 is a flowchart showing a provision process by the slot machine according to the embodiment.

FIG. 11 is a block diagram showing an internal configuration of a slot machine according to a modified example of the embodiment.

FIG. 12 is a perspective view of a display used in the slot machine according to the modified example of the embodiment.

FIG. 13 is an exploded perspective view of the display used in the slot machine according to the modified example of the embodiment.

FIG. 14A is a view showing another example of the symbols to be displayed on the display of the slot machine according to the embodiment.

FIG. 14B is a view showing still another example of the symbols to be displayed on the display of the slot machine according to the embodiment.

FIG. 14C is a view showing yet another example of the symbols to be displayed on the display of the slot machine according to the embodiment.

### DETAILED DESCRIPTION OF THE EMBODIMENT

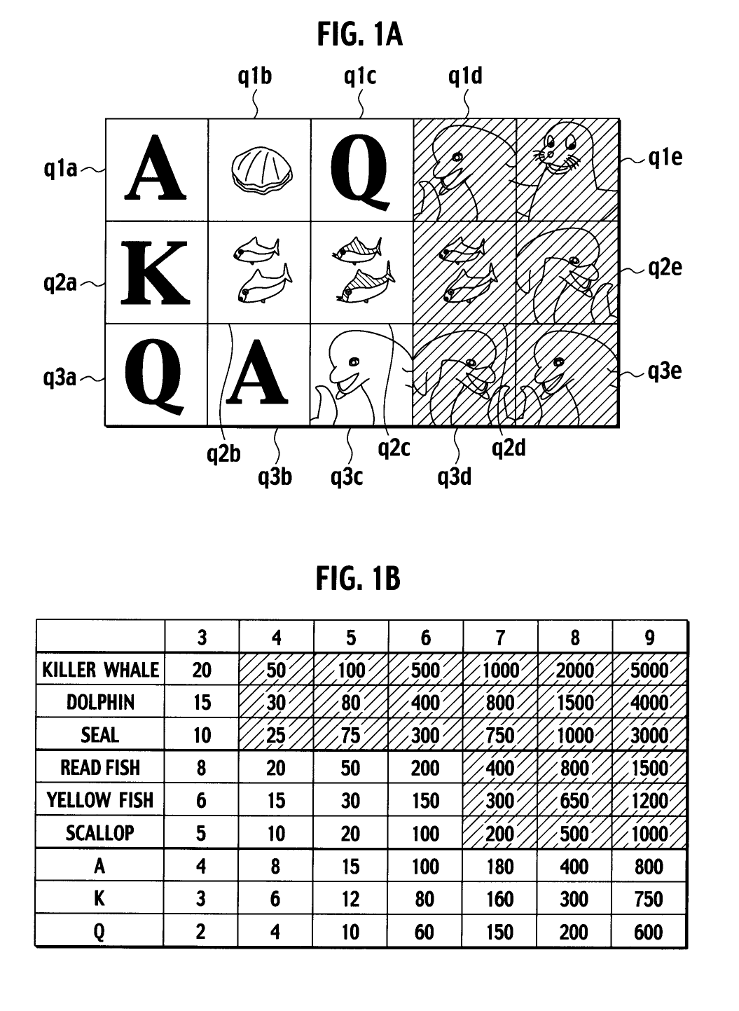

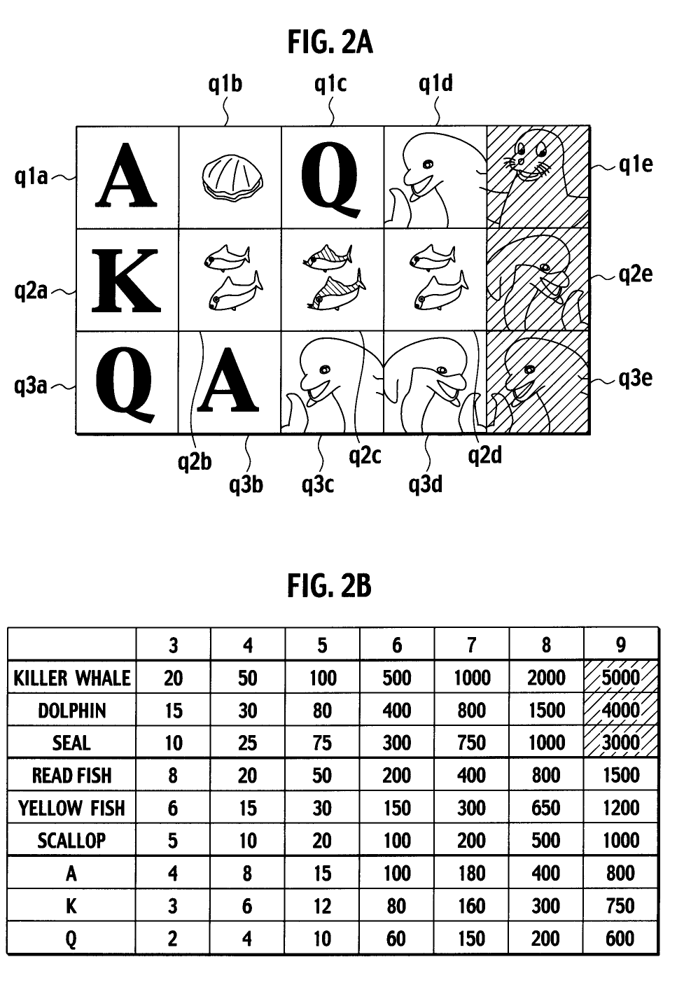

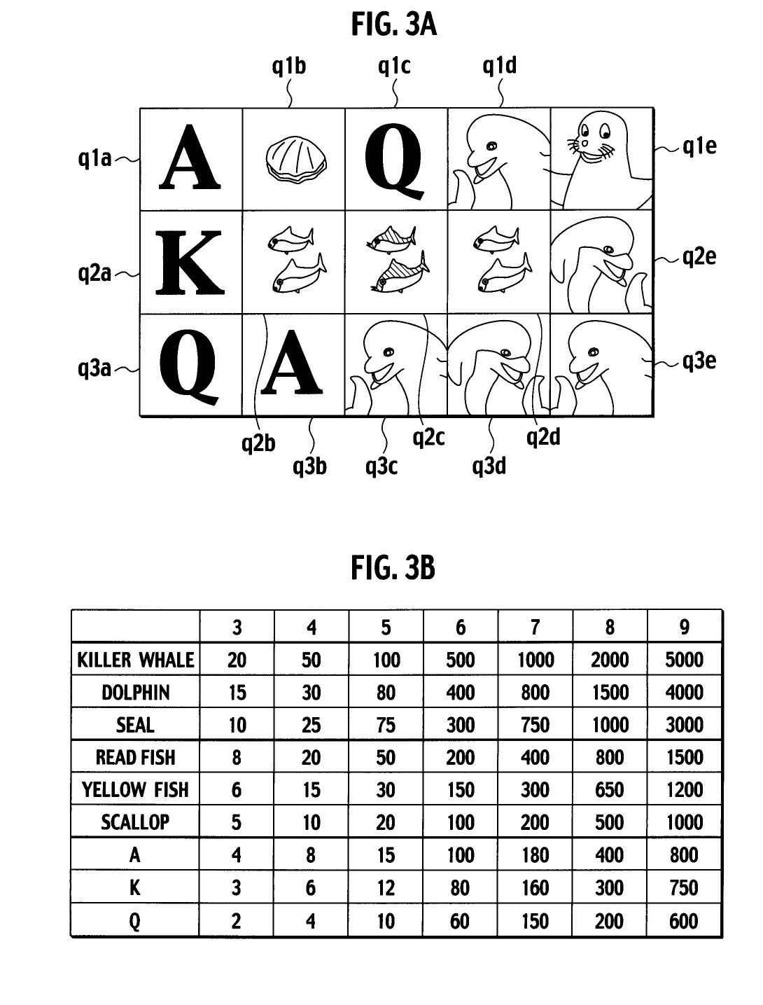

FIG. 1A to FIG. 3B are views for explaining an example of symbols to be displayed on a display and award of a slot machine according to the embodiment. FIG. 1A shows the example of the displayed symbols in the case of a small bet amount (in the case of a minimum bet), FIG. 2A shows the example of the displayed symbols in the case of a medium bet amount, and FIG. 3A shows the example of the displayed symbols in the case of a maximum bet amount. Meanwhile, FIG. 1B shows the example of the award in the case of the small bet amount, FIG. 2B shows the example of the award in the case of the medium bet amount, and FIG. 3B shows the example of the award in the case of the maximum bet amount.

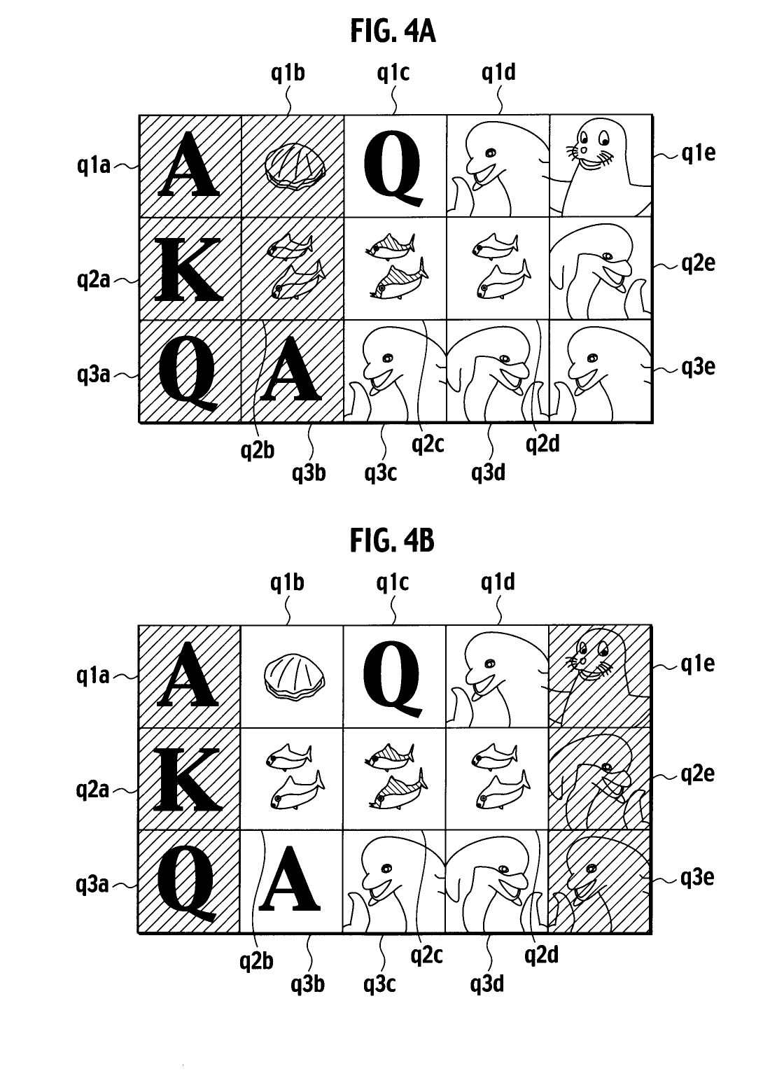

Meanwhile, FIGS. 4A and 4B are views for explaining other example of the displayed symbols in the case of the minimum bet to be displayed on the display of the slot machine according to the embodiment.

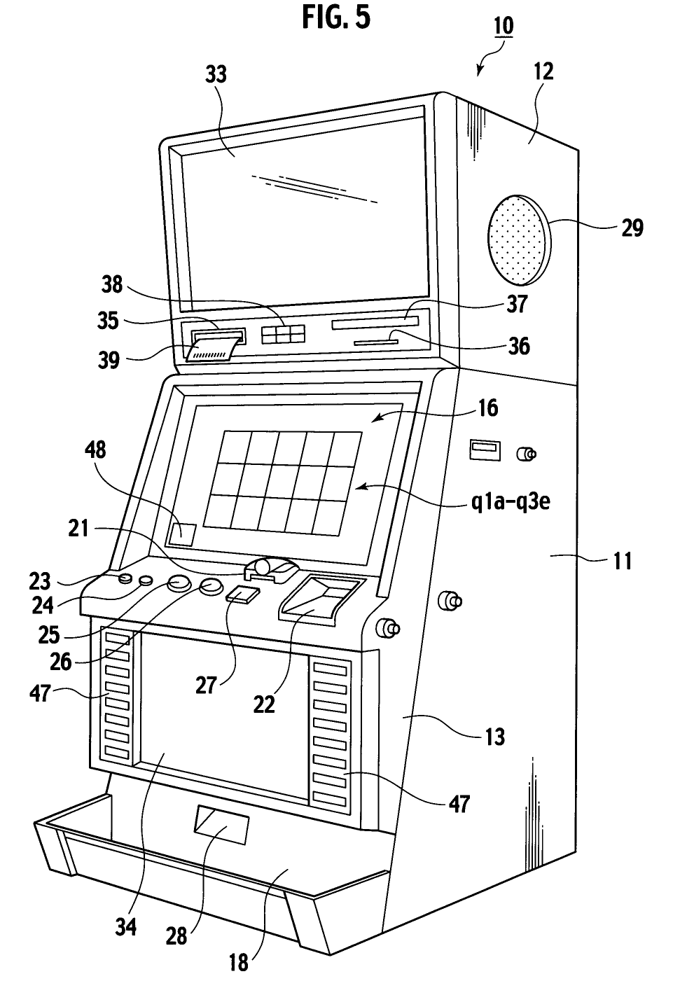

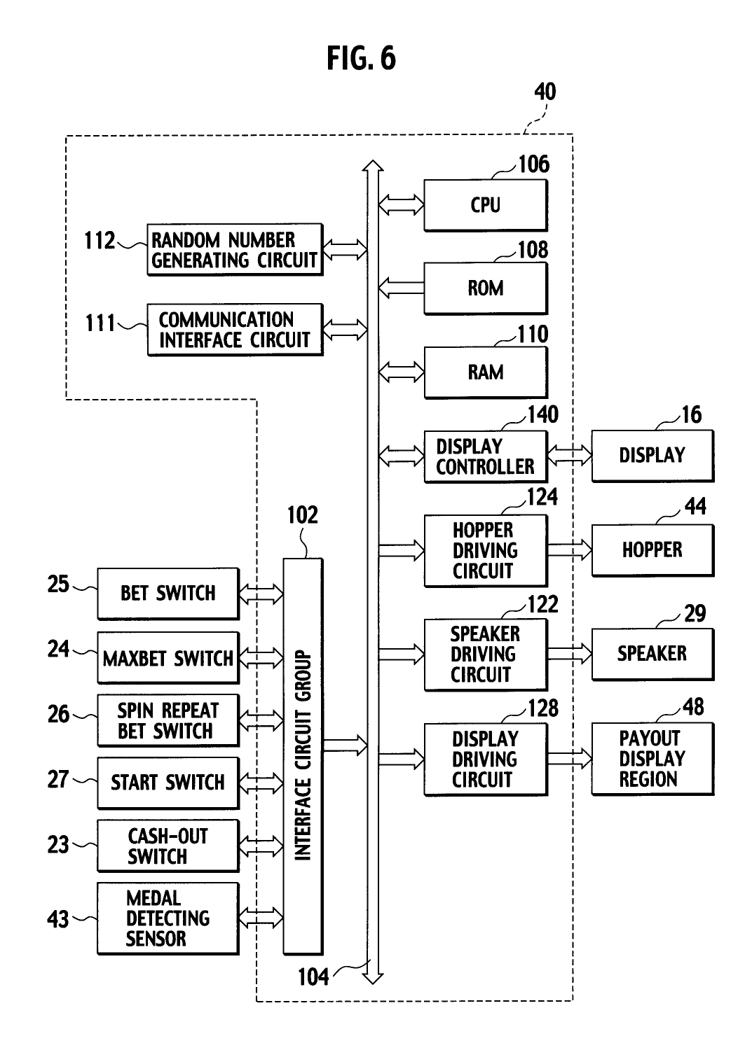

FIG. 5 is an external view of the slot machine according to the embodiment and FIG. 6 is a block diagram showing an electrical configuration of the slot machine according to the embodiment.

According to the slot machine of the embodiment, when a bet in a desired amount is made by a player and a slot game is executed by pressing a start switch 27, three rows and five columns of symbols, i.e., a total of 15 symbols displayed in display region q1a to q3e on a display 16 shown in FIG. 4 start scrolling. Then, the symbols are stopped (the arranged symbols are rearranged) after a predetermined time period. Some of the display regions q1a to q3e are displayed as targeted-symbol display regions, and the targeted-symbol display regions are designed to change according to the amount of bet made by the player. The targeted-symbol display regions here are regions targeted for counting the number of each of predetermined types of symbols. A provision is determined in accordance with a provision table shown in FIG. 1B and how many symbols of each of the predetermined types are displayed in the targeted-symbol display regions.

Specifically, the targeted-symbol display regions occupy three columns from the left in the case of the small bet amount as shown in FIG. 1A, for example. Meanwhile, the targeted-symbol display regions occupy four columns from the left in the case of the medium bet amount as shown in FIG. 2A and the targeted-symbol display regions occupy all the columns (five columns) in the case of the maximum bet amount as shown in FIG. 3A. Here, as shown in FIG. 1A, the targeted-symbol display regions (the three columns on the left) are brightly displayed as usual while regions other than the targeted-symbol display regions (the two columns on the right) are darkly displayed, so that the range of the targeted-symbol display regions (the three columns on the left) is displayed as clearly recognizable to the player. Nevertheless, the regions other than the targeted-symbol display regions (the two columns on the right) are also displayed as discernible to the player.

Moreover, according to the slot machine of the embodiment, number of advantageous symbols (high class symbols) is gradually increased toward the right side of the display region as shown in FIG. 1A, FIG. 2A, and FIG. 3A.

Specifically, as shown in FIG. 1B to FIG. 3B, 20 coins is provided when 3 symbols X with illustration of “killer whale” representing the highest provision possibility (see FIG. 2A) displayed in the targeted-symbol display regions, and 5000 coins is provided when 9 symbols X with illustration of “killer whale” displayed in the targeted-symbol display regions. Meanwhile, 2 coins is provided when 3 symbols Y with illustration of “Q” representing the lowest provision possibility (see FIG. 2A) displayed in the targeted-symbol display regions, and 600 coins is provided when 9 symbols Y with illustration of “Q” displayed in the targeted-symbol display regions.

Moreover, FIG. 1B covers only the three columns on the left as the targeted-symbol display regions, and the symbols displayed in the targeted-symbol display regions in this case are limited to those not shaded in the provision table. Specifically, an image effect to be displayed on the display 16 is controlled in a manner to reduce the probabilities of displaying symbols “killer whale”, “dolphin”, and “seal” that represent higher provision possibilities.

FIG. 2B covers the four columns on the left as the targeted-symbol display regions, and the symbols displayed in the targeted-symbol display regions in this case are limited to those not shaded in the provision table. Specifically, the symbols “killer whale”, “dolphin”, and “seal” that represent higher provision possibilities are more frequently displayed on the right end column.

FIG. 3B covers all the columns as the targeted-symbol display regions which are applied to the case of the maximum bet amount. There are no shaded sections on the provision table and a very high provision can be expected in this case.

In other words, the process to change the targeted-symbol display regions in response to the accepted bets is the process to increase the targeted-symbol display regions in accordance with an increase in the number of bets. Moreover, the display mode on the display is controlled so as to increase the targeted-symbol display regions in accordance with the increase in the amount of bet received by a bet switch.

Further, the display mode on the display is controlled so as to display a fewer number of the symbols providing the higher provision possibilities in the targeted-symbol display regions when receiving a small amount of bet and to display a larger number of the symbols providing the higher provision possibilities in the targeted-symbol display regions when receiving a large amount of bet. In this way, a certain symbol is randomly selected and arranged in each of the targeted-symbol display regions that are to increase according to an increase in the bet amount. In this case, along with the increase in the bet amount, the displaying of symbols is controlled in reference to different table data.

This slot machine has an effect to offer more advantages along the increase in the amount of bet to be made. Therefore, the slot machine can attract the player's interest in betting actions and thereby to improve entertainment properties.

Specifically, the player can also recognize the symbols in the regions other than the targeted-symbol display regions. Here, if the symbols are rearranged as shown in FIG. 1A, for example, no provision is provided because there is no combination of three or more symbols of the same type rearranged in the targeted-symbol display regions. However, the player will notice that three dolphin symbols would have been rearranged in the targeted-symbol display regions, and he or she would have been able to receive a provision equivalent to 15 coins if he or she had made the maximum bet. As a consequence, the player may wish to increase the amount of bet thereafter. In this way, it is possible to attract the player's interest in betting actions.

Next, the principal features of the embodiment will be described.

Here, the display is controlled so that a predetermined minimum number of columns within the symbol display region is displayed as targeted-symbol display regions being targeted for counting the number of symbols of a predetermined type. Moreover, the display is controlled so that the location of the targeted-symbol display regions of the minimum number of columns for the minimum bet amount is shifted within the symbol display region.

Specifically, assuming the small bet amount in the case shown in FIG. 1A as the minimum bet amount, for example, the display regions of three columns, which is the minimum number of columns, are displayed as the targeted-symbol display regions. Moreover, three columns on the left are usually displayed as the targeted-symbol display regions as shown in FIG. 1A. However, the location of the targeted-symbol display regions for the minimum bet amount is shifted to three columns on the right as shown in FIG. 4A after every predetermined-numbered session of slot games.

Meanwhile, the location of the targeted-symbol display regions for the minimum bet amount may be shifted to three columns in the center excluding two columns on both ends as shown in FIG. 4B every time after the predetermined sessions of slot games. Alternatively, the location of the targeted-symbol display regions for the minimum bet amount may be shifted from the location shown in FIG. 1A, then to the location shown in FIG. 4A, and then to the location shown in FIG. 4B after every predetermined-numbered session of slot games.

As described above, in this slot machine, the location of the targeted-symbol display regions for the minimum bet amount is changed after every predetermined-numbered session of slot games. Accordingly, it is possible to attract the player's interest in betting actions and thereby improve entertaining properties.

In this embodiment, the location of the targeted-symbol display regions for the minimum bet amount is changed after every predetermined-numbered session of slot games. However, the present invention is not limited only to this configuration. For example, it is also possible to change the location of the targeted-symbol display regions for the minimum bet amount at predetermined time intervals. Alternatively, it is also possible to change the location of the targeted-symbol display regions for the minimum bet amount randomly by using a random number or the like.

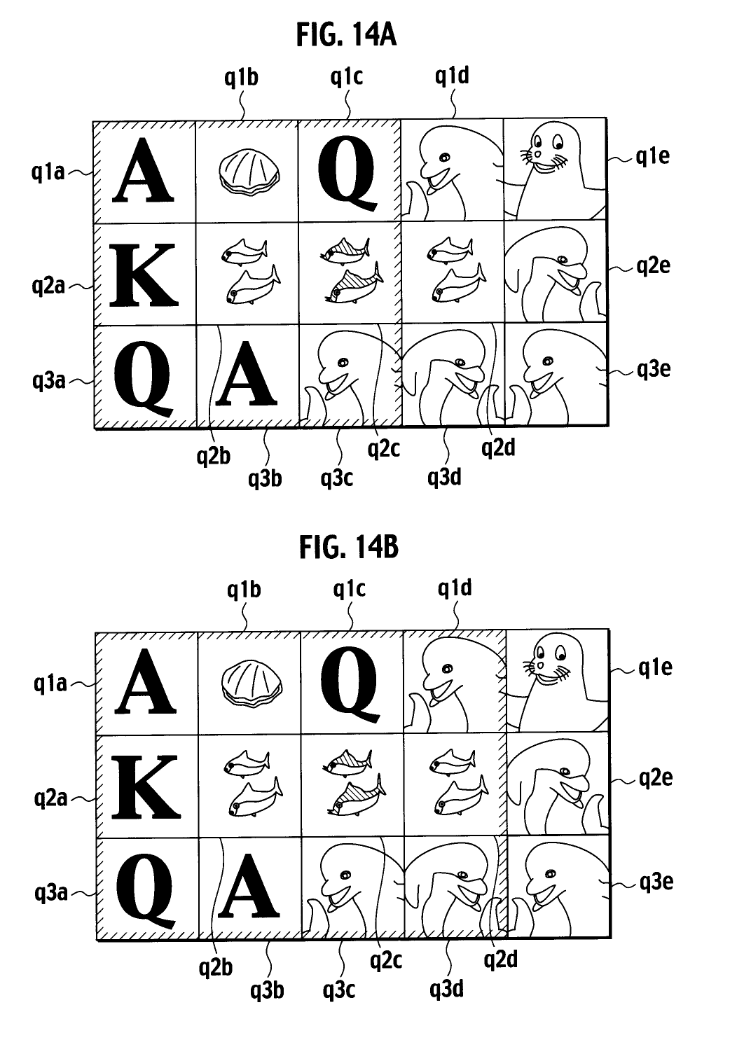

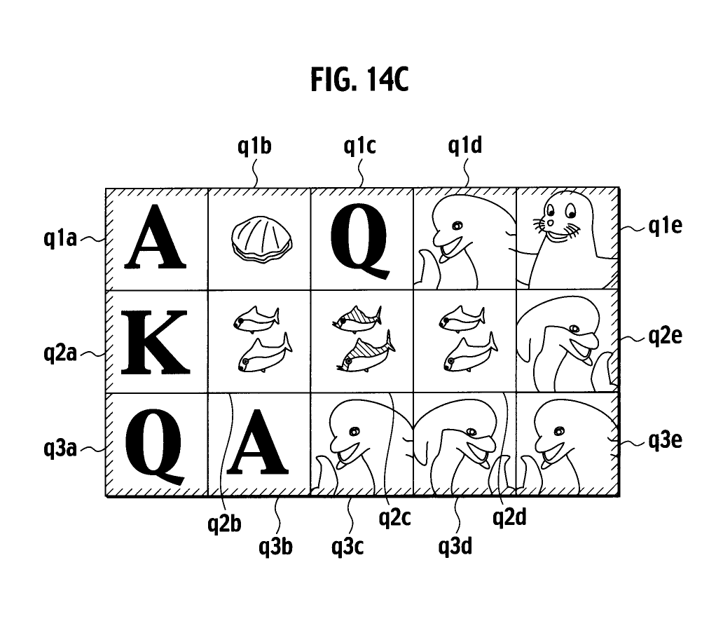

Here, the targeted-symbol display regions (the three columns on the left) are brightly displayed as usual while the regions other than the targeted-symbol display regions (the two columns on the right) are darkly displayed as shown in FIGS. 1A. However, as other display examples, it is also possible to display the enclosure image which surrounds the targeted-symbol display regions so as to notify that the regions surrounded by the enclosure image represent the targeted-symbol display regions as shown in FIGS. 14A, 14B, and 14C. That is, it is possible to apply any display method so far as such a method can appropriately notify the player of the targeted-symbol display regions.

Next, a configuration of a slot machine 10 of this embodiment will be described more in detail. As shown in FIG. 5, the slot machine 10 of this embodiment includes a cabinet 11, a top box 12 provided on an upper side of the cabinet 11, and a main door 13. The cabinet 11 is provided with the display 16 placed on a face opposed to a player. Moreover, various constituent members such as a controller 40 (see FIG. 6) configured to electrically control this slot machine 10 and a hopper 44 (see FIG. 6) configured to control insertion, storage, and discharge of medals are provided inside the cabinet 11.

While medals are used as an example of game media used for executing a game in this embodiment, the game media are not limited only to the medals. For example, it is also possible to use coins, tokens, electronic money, or other electronic value information (credits) corresponding thereto.

The main door 13 is openably and closably fitted to the cabinet 11, and the display 16 of a liquid crystal display device or the like is provided substantially in the center of the main door 13. As will be described later, the display 16 is adapted to display images concerning various games including the slot game. Symbols disposed in the 15 display region q1a to q3e arranged in the matrix of three rows and five columns as shown in FIG. 5 are scrolled and then stopped (the arranged symbols are rearranged) in a slot game.

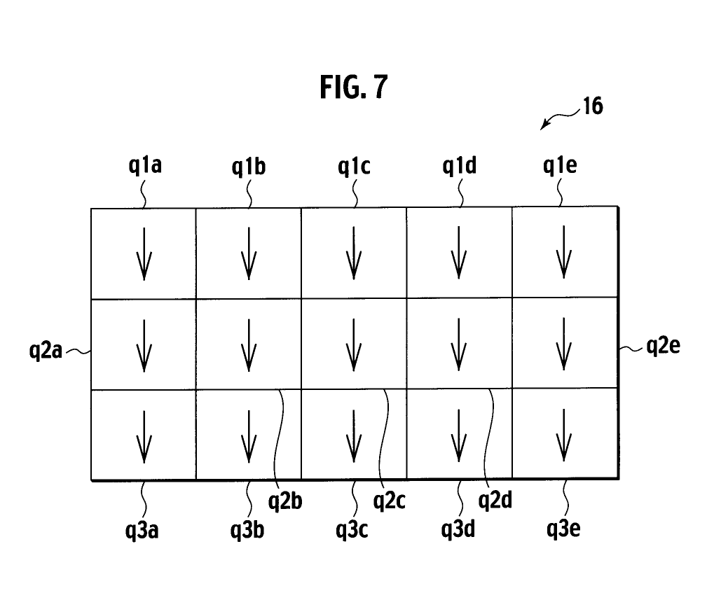

Here, as shown in FIG. 7, the suffixes a to e attached to the display region q indicate the columns while the suffixes 1 to 3 indicate the rows. Although the display region used for execution of the slot game is formed of the matrix including three rows and five columns in this embodiment, the present invention is not limited only to this configuration.

Meanwhile, a provision amount display region 48 adapted to display an amount of provision is provided in a lower left region of the display 16 shown in FIG. 5.

A medal insertion slot 21 configured to allow insertion of medals used for playing the slot game and a bill validator 22 configured to validate appropriate bills and to accept authentic bills are provided below the display 16. Moreover, various operation switches are provided in the vicinity of the medal insertion slot 21 and the bill validator 22.

A cash-out switch 23, a MAXBET switch 24, a BET switch 25, a spin repeat BET switch 26, and the start switch 27 are provided as the operation switches.

The BET switch 25 is the switch for deciding the amount of credits to be bet on a slot game executed on the display 16. A credit equivalent to one medal is bet every time pressing the BET switch 25.

The spin repeat BET switch 26 is the switch for executing a slot game by betting credits without changing the amount of credits bet in the previous game by using the BET switch 25.

The start switch 27 is the switch for starting the slot game on the display 16 after making a bet of credits. The slot game is started in each of the display regions q1a to q3e on the display 16 when this start switch 27 is pressed down after inserting the medals to the medal insertion slot 21 or making the bet of credits by using the BET switch 25.

The cash-out switch 23 is the switch for cashing out the inserted medals. The medals to be cashed out are discharged from a medal provision opening 28 provided at a lower part on the front face of the main door 13. The discharged medals are pooled in a medal tray 18.

The MAXBET switch 24 is the switch for betting the maximum amount of credits (such as credits corresponding to thirty medals) that the player can bet in one game session in a single operation.

A foot display 34 is provided on the lower part of the front face of the main door 13 and is adapted to display various images concerning the games with the slot machine 10. The images include characters of the slot machine 10, for example.

Lamps 47 are provided on both sides of the foot display 34 and are configured to emit light based on a preset light emission pattern corresponding to the playing condition of the slot machine 10. The medal provision opening 28 is provided below the foot display 34.

An upper display 33 is provided on a front face of the top box 12.

Moreover, the top box 12 is provided with a speaker 29. A ticket printer 35, a card reader 36, a data display 37, and a keypad 38 are provided on a lower side of the upper display 33. The ticket printer 35 is configured to print a bar code, which represents encoded data on the amount of credits, date and time, an identification number of the slot machine 10 and the like, on a ticket and to output a bar coded ticket 39.

A player may allow another slot machine to read the bar coded ticket 39 and to play games with that slot machine or exchange the bar coded ticket 39 with money bills and the like at a predetermined location in a gaming arcade (such as a cashier in a casino).

The card reader 36 allows insertion of a smart card and is configured to read data out of the inserted smart card and to write data into the smart card. The smart card is a card carried by the player, which stores data for identifying the player, data concerning a history of games played by the player, and the like.

FIG. 6 is a block diagram showing an electrical configuration of a controller 40 provided in the slot machine 10 of this embodiment and various devices to be connected to this controller 40. The controller 40 of the slot machine 10 shown in FIG. 4 is a microcomputer which includes an interface circuit group 102, an input-output bus 104, a CPU (central processing unit) 106, a ROM (read-only memory) 108, a RAM (random access memory) 110, a communication interface circuit 111, a random number generating circuit 112, a speaker driving circuit 122, a hopper driving circuit 124, a display driving circuit 128, and a display controller 140.

The interface circuit group 102 is connected to the input-output bus 104 and this input-output bus 104 inputs and outputs data signals and address signals to and from the CPU 106.

The start switch 27 is connected to the interface circuit group 102. A start signal outputted from this start switch 27 is converted into a given signal by the interface circuit group 102 and is then transmitted to the CPU 106 through the input-output bus 104.

Further, the BET switch 25, the MAXBET switch 24, the spin repeat BET switch 26, and the cash-out switch 23 are connected to the interface circuit group 102. Moreover, each switching signals outputted from these switches 25, 24, 26, and 23 are supplied to the interface circuit group 102, then converted into given signals by this interface circuit group 102, and then transmitted to the CPU 106 through the input-output bus 104.

In addition, a medal detecting sensor 43 is connected to the interface circuit group 102. The medal detecting sensor 43 is the sensor for detecting the medals inserted to the medal insertion slot 21, and is provided at a medal insertion region of the medal insertion slot 21. A detection signal outputted from this medal detecting sensor 43 is supplied to the interface circuit group 102, then converted into a given signal by this interface circuit group 102, and then transmitted to the CPU 106 through the input-output bus 104.

The ROM 108 for storing system programs and the RAM 110 for saving various data are connected to the input-output bus 104. Moreover, the random number generating circuit 112, the communication interface circuit 111, the display controller 140, the hopper driving circuit 124, the speaker driving circuit 122, and the display driving circuit 128 are connected to the input-output bus 104.

Taking acceptance of a starting operation of a game by the start switch 27 as a trigger, the CPU 106 reads out a game execution program and executes a slot game. The game execution program is the program for executing slot game on the display 16 by way of the display controller 140.

Specifically, the game execution program is programmed to execute a slot game by scrolling the symbols in the each display regions q1a to q3e (see FIG. 6), then stopping the symbols (rearranging the arranged symbols), and providing an award according to the stopped symbols and points attributed to those symbols.

Here, the CPU 106 is configured to count the number of executed sessions of the slot games and to store the counted value in the RAM 110 or the like.

The communication interface circuit 111 is connected to a hall server, for example, and transmits data such as a play history executed by the slot machine 10 to the hall server. Meanwhile, the communication interface circuit 111 receives various data transmitted from the hall server.

The random number generating circuit 112 generates a random number for determining whether or not it is appropriate to grant the winning in the slot game executed on the display 16.

The display driving circuit 128 performs control to display an amount of provision in the provision amount display region 48 defined in the lower left region of the display 16.

The speaker driving circuit 122 outputs voice data to the speaker 29. Specifically, the CPU 106 reads the voice data stored in the ROM 108 and transmits the voice data to the speaker driving circuit 122 through the input-output bus 104. In this way, predetermined sound effects are outputted from the speaker 29.

The hopper driving circuit 124 outputs a provision signal to the hopper 44 when a cash-out becomes effective. Specifically, when a cash-out signal is inputted from the cash-out switch 23, the CPU 106 outputs a driving signal to the hopper driving circuit 124 through the input-output bus 104. Accordingly, the hopper 44 provides the medals corresponding to the remaining amount of credits at that point stored in a given memory region of the RAM 110.

The display controller 140 performs display control to execute the slot game on the display 16. Specifically, the CPU 106 generates an image display instruction signal corresponding to a state of the slot game and an outcome of the slot game. Then, the CPU 106 outputs the image display instruction signal to the display controller 140 through the input-output bus 104. When the image display instruction signal outputted from the CPU 106 is inputted to the display controller 140, the display controller 140 generates a driving signal for driving the display 16 based on the image display instruction signal and outputs the generated driving signal to the display 16. In this way, a predetermined image is displayed on the display 16.

Here, this display 16 includes a liquid crystal display device, and is adapted to display the symbols by varying and arranging the symbols in the display regions q1a to q3e based on the image display instruction signal transmitted from the CPU 106 through the input-output bus 104, and to change the targeted-symbol display regions among the display regions q1a to q3e on the display 16 based on the amount of bet made by the player. In other words, the display 16 is adapted to display the targeted-symbol display regions brightly and the regions other than the targeted-symbol display regions darkly.

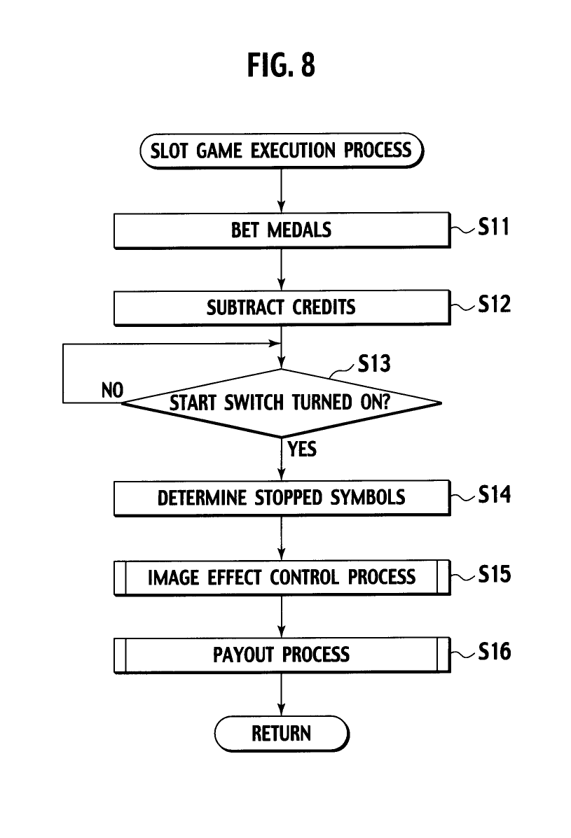

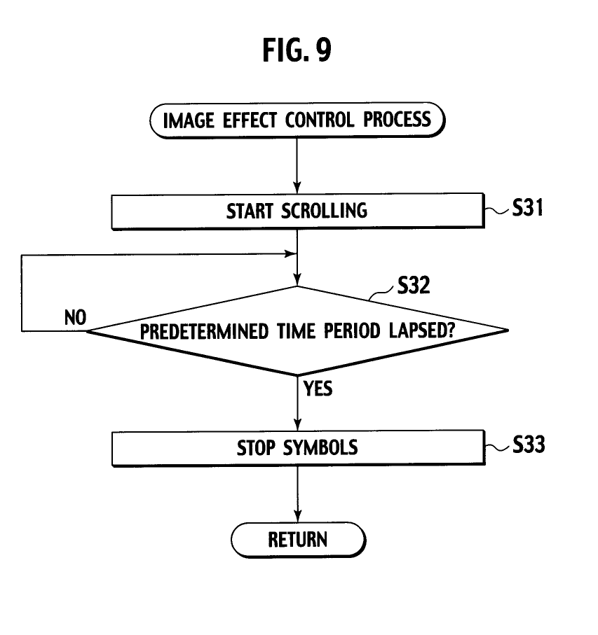

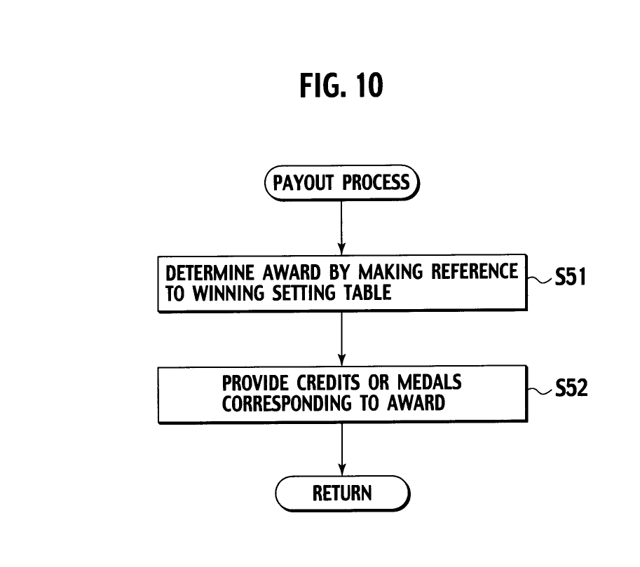

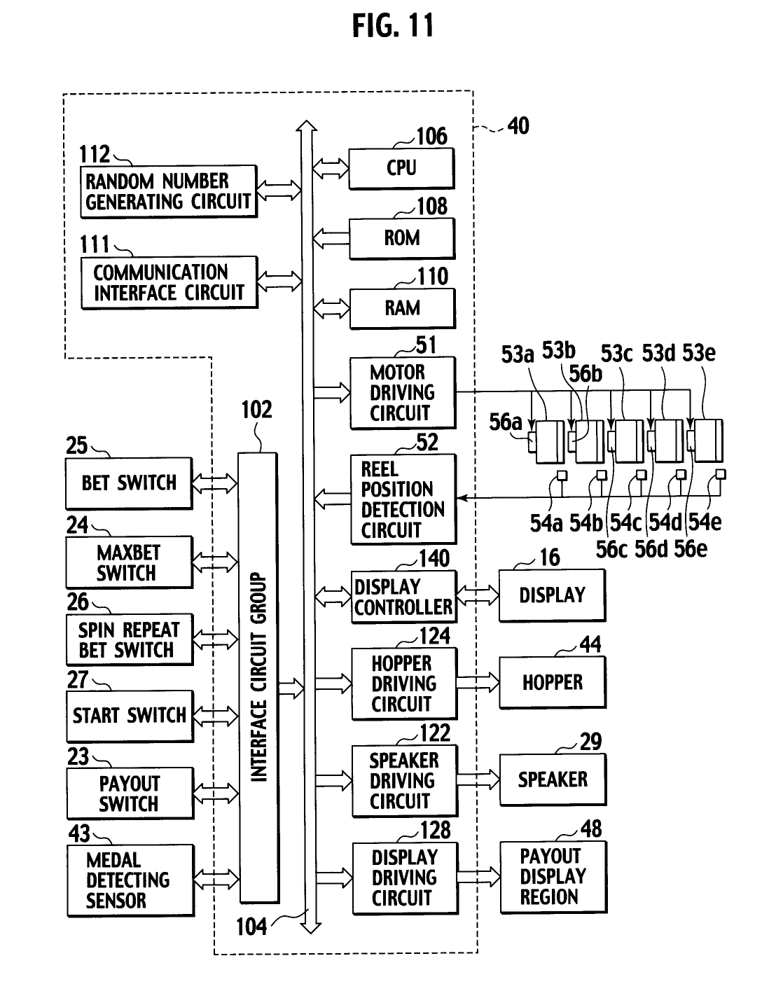

Next, operations of the slot machine 10 according to the embodiment of the present invention will be described with reference to flowcharts shown in FIG. 8, FIG. 9, and FIG. 10. FIG. 8 is a flowchart showing procedures of an execution process of the slot game executed by the slot machine 10 according to the embodiment.

First, the CPU 106 shown in FIG. 6 receives a bet of medals or credits by the player (step S11). Specifically, when the player makes a bet in a desired amount of credits by pressing the BET switch 25 or inserts the desired amount of medals into the medal insertion slot 21, this amount is inputted as the bet amount.

When the bet is made by pressing the BET switch 25, the CPU 106 subtracts the credits equivalent to the bet amount from current credits (step S12). For example, if the bet in an amount of “10” credits is made while having the current credits equal to “30”, the remaining credits will become “20” as a result of subtraction.

Here, the CPU 106 stores the accepted bet amount in the RAM 110 or the like.

The CPU 106 determines whether or not the start switch 27 is turned on (step S13). When the start switch 27 is turned on (YES in step S13), the CPU performs a stopped symbol determination process (step S14). In this process, the symbols to be displayed on the each display regions q1a to q3e are determined based on random numbers obtained from the random number generating circuit 112.

Here, the CPU 106 is configured to perform the stopped symbol determination process such that symbols for a higher award may be sometimes displayed in the targeted-symbol display regions of the minimum number of columns for the minimum bet amount, though the symbols for the higher award are to be displayed in the targeted-symbol display regions for a bet amount higher than the minimum bet amount. Moreover, the CPU 106 is configured to perform the stopped symbol determination process such that a symbol for the highest award may sometimes be displayed in targeted-symbol display regions of each of the maximum number of columns, in the case where the bet switch receives the maximum bet amount.

The CPU 106 executes an image effect control process (step S15). In this process, the stopped symbols determined in step S14 are displayed on the each display regions q1a to q3e. The image effect control process will be described later in detail.

Subsequently, the CPU 106 performs a provision process based on the symbols displayed in the each display regions q1a to q3e (step S16). The provision process will be described later in detail.

Next, the image effect control process shown in step S15 of FIG. 8 will be described with reference to FIG. 9.

First, the CPU 106 outputs an instruction signal for starting scroll display of the symbols to the display controller 140. When this instruction signal is inputted through the display controller 140, the CPU 106 starts scrolling the symbols in each of the display regions q1a to q3e on the display 16. At this time, the columns of the targeted-symbol display regions determined based on the bet amount are brightly displayed while non-targeted-symbol display regions are darkly displayed (step S31).

Here, the CPU 106 judges whether or not the counted value of executed slot games reaches a predetermined value (such as 10 sessions). If the counted value does not reach 10 sessions, the CPU 106 displays the targeted-symbol display regions as follows.

Specifically, in the case of the small bet amount such as 10 medals or credits, for example, the targeted-symbol display regions are defined as three columns on the left covering the regions q1a to q3a, q1b to q3b, and q1c to q3c as shown in FIG. 1A. In the case of a medium bet amount such as 20 medals or credits, for example, the targeted-symbol display regions are defined as four columns on the left covering the regions q1a to q3a, q1b to q3b, q1c to q3c, and q1d to q3d as shown in FIG. 2A. In the case of a maximum bet amount such as 30 medals, for example, the targeted-symbol display regions are defined as all the columns (five columns) covering the regions q1a to q3a, q1b to q3b, and q1c to q3c, q1d to q3d, and q1e to q3e as shown in FIG. 3A. In any of these cases, the targeted-symbol display regions are brightly displayed.

Next, if the counted value of the executed slot games reaches the predetermined value (such as 10 sessions), the CPU 106 displays the targeted-symbol display regions as follows.

Specifically, in the case of the minimum bet amount (in the case of 10 medals or credits), the location of the targeted-symbol display regions is shifted from the regions occupying the three columns q1a to q3a, q1b to q3b, and q1c to q3c on the left as shown in FIG. 1A to the regions occupying three columns q1c to q3c, q1d to q3d, and q1e to q3e on the right as shown in FIG. 4A, for example.

Here, the CPU 106 is configured to perform control of the display regions on the display 16 including a liquid crystal display device through the display controller 140 based on the stored bet amount.

In this embodiment, the location of the targeted-symbol display regions for the minimum bet amount is changed every time after the predetermined sessions of slot games. However, the present invention is not limited only to this configuration. For example, it is also possible to change the location of the targeted-symbol display regions for the minimum bet amount every time after at predetermined time intervals. Alternatively, it is also possible to change the location of the targeted-symbol display regions for the minimum bet amount randomly by using a random number or the like.

Here, the targeted-symbol display regions (the three columns on the left) are brightly displayed as usual while the regions other than the targeted-symbol display regions (the two columns on the right) are darkly displayed as shown in FIG. 1A. As other display examples, it is also possible to display the enclosure image of the targeted-symbol display regions to surround the targeted-symbol display regions in order to notify that the regions surrounded by an enclosure image represent the targeted-symbol display regions, as illustrated in FIGS. 14A, 14B, and 14C. That is, it is possible to apply any display method so far as such a method can appropriately notify the player of the targeted-symbol display regions.

Next, the CPU 106 measures a time lapse from the start of scrolling the symbols (step S32). When a lapse of a predetermined time period (such as 5 seconds) is confirmed (YES in step S32), the CPU 106 sequentially stops the symbols in the each display regions q1a to q3e (step S33). As a consequence, in the case of the bet equivalent to 10 medals or credits, for example, the three columns on the left are displayed as the targeted-symbol display regions q1a to q3a, q1b to q3b, and q1c to q3c while the two columns on the right are displayed as non-targeted-symbol display regions q1d to q3d and q1e to q3e, as shown in FIG. 1. The symbols are displayed in the each display regions.

Then, this process is terminated.

Next, the provision process shown in step S16 in FIG. 8 will be described with reference to FIG. 10.

First, in step S51, the award is determined with reference to a winning setting table. For example, when the symbols are rearranged as shown in FIG. 3A in a game of the maximum bet amount (equivalent to 30 medals or credits), reference is made to the winning setting table shown in FIG. 3B. In this case, three dolphin symbols appear in the targeted-symbol display regions. Accordingly, the award equivalent to 15 medals is determined.

Subsequently, the CPU 106 provides credits or medals corresponding to the determined winning (step S51). Specifically, when the symbols are rearranged as shown in FIG. 3A in the game of the maximum bet amount, 15 medals or credits is provided. In this way, the provision process is carried out.

Here, when the symbols are rearranged as shown in FIG. 2A in the game of the medium bet amount (20 medals or credits), for example, reference is made to the winning setting table shown in FIG. 2B. In this case, there are not three or more symbols of the same type appearing in the targeted-symbol display regions. Accordingly, an award equivalent to 0 medals is determined.

Meanwhile, when the symbols are rearranged as shown in FIG. 1A in the game of the minimum bet amount (10 medals or credits), for example, reference is made to the winning setting table shown in FIG. 1B. In this case, there are no three or more symbols of the same type appearing in the targeted-symbol display regions. Accordingly, a winning equivalent to 0 medals is determined.

Moreover, when the counted value of the executed slot games reaches the predetermined value (such as 10 sessions) and the symbols are rearranged in the targeted-symbol display regions that are shifted as shown in FIG. 4A at the minimum bet amount (10 medals or credits), for example, reference is made to the winning setting table shown in FIG. 1B. In this case, there are three symbols of the same type (dolphins) appearing in the targeted-symbol display regions. Accordingly, a winning equivalent to 15 medals is determined.

As described above, in this slot machine, the location of the targeted-symbol display regions for the minimum bet amount is changed every time after the predetermined sessions of slot games. Accordingly, it is possible to attract the player's interest in betting actions and thereby to improve entertaining properties.

Next, a modified example of the slot machine 10 according to the above-described embodiment will be described. As shown in FIG. 10, the slot machine 10 according to the modified example is configured to drive rotatable reels 53a to 53e provided with the symbols on circumferential surfaces thereof by using a motor driving circuit 51 and to vary and rearrange the symbols while detecting positions with a reel position detection circuit 52. As described in the embodiment, as for the rotatable reels 53a to 53e, number of high class symbols increases for the reel positioned to the right.

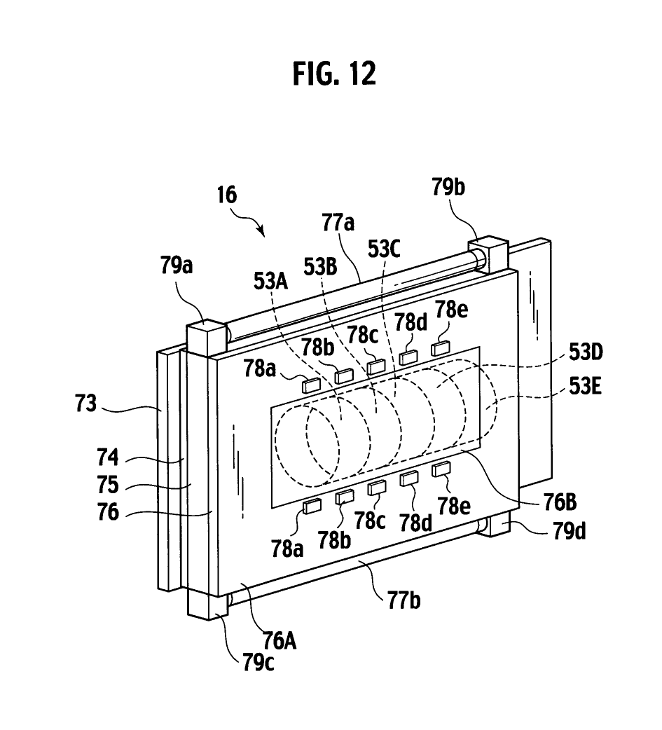

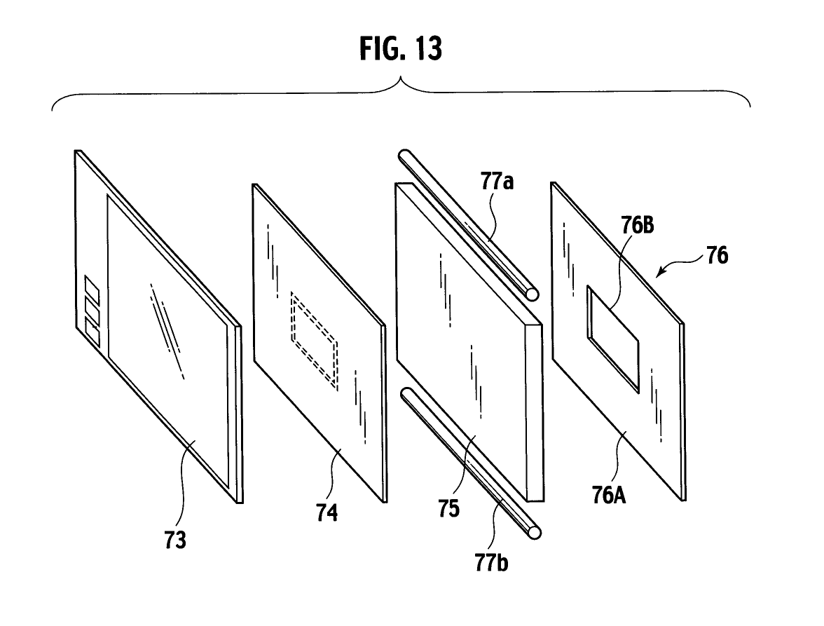

Meanwhile, the display 16 has a configuration as shown in FIG. 12 and 13 so as to allow the targeted-symbol display regions to occupy three columns on the left in the case of the small bet amount as shown in FIG. 1A, four columns on the left in the case of the medium bet amount as shown in FIG. 2A, and all the columns (five columns) in the case of the maximum bet amount as shown in FIG. 3A. Moreover, the location of the targeted-symbol display regions at the minimum bet is changed every time after the predetermined sessions of slot games.

Specifically, FIG. 12 is a perspective view showing appearance of the display 16 viewed from a back face side and FIG. 13 is an exploded perspective view showing the configuration of the display 16 shown in FIG. 12. Note that some constituents shown in FIG. 12 are omitted in FIG. 13.

As shown in FIGS. 12 and 13, the display 16 includes a display plate 73, a transparent liquid crystal panel 74, a light guiding plate 75, and a reflection film 76, which are disposed from the front face side of the slot machine 10 in this order. Moreover, a rotatable reel device 53 including reels 53a to 53e is disposed on the back face side of the display 16.

Moreover, the display 16 includes fluorescent lamps 77a and 77b, and lamp holders 79a to 79d for supporting the fluorescent lamps 77a and 77b. The fluorescent lamps 77a and 77b, and the lamp holders 79a to 79d are located above and below the light guiding plate 75.

The display plate 73 is the component to define an image display region 61 for displaying various effect images, which is made of a transparent member. A region located on the front face side of the each reels 53a to 53e (a symbol display region 62) on image display region is usually set to a transparent state for display so that the symbols drawn on the each reels 53a to 53e are visually recognizable through the symbol display region 62. Meanwhile, a region within the image display region 61 excluding the symbol display region 62 is set to a state of image display and various images are displayed therein.

The transparent liquid crystal panel 74 is formed by sealing liquid crystal into a clearance between a transparent base plate such as a glass plate provided with a thin film transistor layer and another transparent base plate opposed thereto. This transparent liquid crystal panel 74 is configured to be transparent in a normal state, i.e. a state of not performing liquid crystal display. Therefore, the transparent liquid crystal panel 74 performs transparent display when the liquid crystal is not driven, whereby the light passing through the transparent liquid crystal panel 74 to a display surface side is visible to outside. This state represents the above-mentioned state of transparent display. Meanwhile, this transparent liquid crystal panel 74 can also partially perform semi-transparent display by driving a certain part of liquid crystal.

Here, when the slot game in the maximum bet amount is executed, the symbol display region 62 located substantially in the center of the transparent liquid crystal display 74 is entirely not driven so as to allow the player to visually check all the reels 53a to 53e.

In the case of the small bet amount, a portion of the display region corresponding to three columns on the left is set to a transparent state to achieve bright display while a portion of the display region corresponding to two columns on the right is set to a semi-transparent state to achieve dark display. Meanwhile, in the case of the medium bet amount, a portion of the display region corresponding to four columns on the left is set to the transparent state to achieve bright display while a portion of the display region corresponding to one column on the right is set to a semi-transparent state to achieve dark display.

Alternatively, it is also possible to drive the symbol display region 62 according to effects using images to display various images as appropriate.

The light guiding plate 75 is configured to guide light from the fluorescent lamps 77a and 77b to the transparent liquid crystal panel 74, and thereby to illuminate the transparent liquid crystal panel 74. To be more precise, the light guiding plate 75 is a transparent member made of acrylic resin having a thickness of about 2 cm, which has a light guiding function.

The reflection film 76 is typically formed of depositing a silver film either on a white polyester film or an aluminum thin film, and is configured to reflect the light guided into the light guiding plate 75 toward a front face side of the light guiding plate 75. This reflection film 76 includes a reflective region 76A and a non-reflective region 76B. The non-reflective region 76B is made of a transparent material and is provided in a region corresponding to the reels 53a to 53e.

The fluorescent lamps 77a and 77b are disposed along an upper end and a lower end of the light guiding plate 75, and ends of the lamps 77a and 77b are supported by the lamp holders 79a to 79d. The light from these lamps 77a and 77b is reflected by the reflective region 76A of the reflection film 76 and thereby illuminates the transparent liquid crystal panel 74.

Meanwhile, lamps 78a to 78e made of light emitting diodes (LEDs) or the like are provided on upper parts and lower parts of the respective reels 53a to 53e, on the back side of the reflection film 76. The lamps 78a to 78e are disposed so as to emit light toward the respective reels 53a to 53e. The light emitted from these lamps 78a to 78e is reflected on surfaces of the respective reels 53a to 53e. Then, part of the light emitted from the lamps 78a to 78e reflected by the surfaces of the reels 53a to 53e is incident on the non-reflective region 76B to illuminate the transparent liquid crystal panel 74.

In essence, when the region (the symbol display region 62) of the transparent liquid crystal panel 74 located at the front face side of all the reels 53a to 53e is set to transparent state, and when all the lamps 78a to 78e provided on the upper parts and the lower parts of the reels 53a to 53e are turned on, the symbol display region 62 is set to the state of transparent display, so that the player can see all the reels 53a to 53e provided at the back face side of the transparent liquid crystal panel 74

Although the embodiment has been described herein above, the embodiment is only showing a specific example, and does not particularly limit the present invention. Accordingly, the specific configuration of each means or the like can be modified in design appropriately. In addition, the effects described in the embodiment are only listing the most preferable effects that arise from the present invention. For this reason, the effects produced by the present invention are not limited to those described in the embodiment.

In addition, in the foregoing detailed description, the characteristic portions of the present invention have been mainly described in order to make the present invention easily understandable. The present invention is not limited to the embodiment described above in detail, and can be applied to other embodiments, and its applicable range is wide. Moreover, the terms and the terminology used in the present specification are used for the purpose of precisely explaining the present invention, and not used for the purpose of limiting interpretations of the present invention. Further, it should be easy for those skilled in the art to contemplate other configurations, systems, methods, etc., which are included in the concept of the present invention, from the concept of the present invention described in the present specification. For this reason, the description of the appended claims must be construed as containing equivalent configurations within a range not departing from the technical ideas of the present invention. Moreover, the abstract aims to allow the United States Patent and Trademark Office, general public office, and engineers who are not familiar with a patent, legal terms, and technical terms, and who pertain to the technical field of the present invention, to quickly judge the technical content and essence of the present application with a simple study. Accordingly, the abstract is not intended to limit the scope of the invention that should be assessed from the description of the appended claims. Furthermore, it is desirable that the present invention be interpreted by fully taking already-disclosed literatures and the like into consideration in order to fully understand the object of the present invention and unique effects of the present invention.

The foregoing detailed description includes the processing executed by a computer. The above description and expressions are described in order for those skilled in the art to understand the present invention in the most efficient way. In this specification, each step used for deriving one result should be understood as processing without self-contradiction. Moreover, in each step, transmission, reception, storage, etc., of an electric or magnetic signal is performed. Expressions such as bit, value, symbol, letter, term, number, and the like are used to express such a signal in the processing in each step, but it should be noted that these are simply used to make the explanation easy. In addition, the processing in each step is sometimes described in an expression in common with human activities, but the processing described in this specification is primarily executed by various types of devices. Furthermore, other configurations required for executing each step is obvious from the foregoing description.

What is claimed is:

1. A slot machine comprising:
(a) a display provided with display regions to arrange and display a plurality of symbols on a plurality of columns;
(b) a bet switch configured to receive a bet from a player; and
(c) a controller operable to:
(A) execute a slot game upon receipt of an external input, by rearranging the symbols arranged in the display regions, and by awarding a winning if a predetermined number of symbols of a predetermined type are displayed; and
(B) when rearranging the symbols if the bet switch receives a minimum bet amount, control the display so that a predetermined minimum number of columns within the symbol display regions are displayed as targeted-symbol display regions being targeted for counting a number of symbols of the predetermined type.

2. The slot machine according to claim 1, wherein
the controller controls the display so that a location of the targeted-symbol display regions of the minimum number of columns in the case of the minimum bet amount is changed within the symbol display regions.

3. The slot machine according to claim 2, wherein
when rearranging the symbols, the controller controls a display mode of the display so that the number of columns of the targeted-symbol display regions is increased according to an increase in the bet amount.

4. The slot machine according to claim 3, wherein
the controller controls the display mode of the display so that an increased number of symbols for a higher award according to the increase in the bet amount are displayed in the targeted-symbol display regions, by randomly determining and arranging types of symbols in every column of the targeted-symbol display regions that increase according to the increase in the bet amount.

5. The slot machine according to claim 1, wherein
the controller controls the display to show a range of the targeted-symbol display regions to a player by displaying the targeted-symbol display regions and a region other than the targeted-symbol display regions in different display modes.

6. The slot machine according to claim 4, wherein
the controller controls the display mode of the display so that a symbol for a higher award is displayed in the targeted-symbol display regions of the predetermined minimum number of columns in the case of the minimum bet amount, the symbol being to be displayed in the targeted-symbol display regions in a case of a bet amount higher than the minimum bet amount.

7. The slot machine according to claim 4, wherein
when the bet switch receives a maximum bet amount, the controller controls the display mode of the display so that a maximum number of columns of the display regions are displayed as the targeted-symbol display regions, and that a symbol for a highest award is displayed on every column in the display regions of the maximum number of columns.

8. A slot machine comprising:
(a) a plurality of rotatable reels each including a plurality of symbols on a side surface;
(b) a display being disposed at front face sides of the reels and including an image display region having display regions to display the symbols on the plurality of reels;
(c) a bet switch configured to receive a bet from a player; and
(d) a controller operable to:
(A) execute a slot game upon receipt of an external input, by rearranging the symbols arranged in the display regions by rotating and by stopping the reels, and awarding a winning if a predetermined number of symbols of a predetermined type are displayed; and
(B) when rearranging the symbols if the bet switch receives a minimum bet amount, control the display so that a predetermined minimum number of columns within the symbol display regions are displayed as targeted-symbol display regions being targeted for counting a number of symbols of the predetermined type.

9. The slot machine according to claim 8, wherein
the controller controls the display so that a location of the targeted-symbol display regions of the minimum number of columns in the case of the minimum bet amount is changed within the symbol display regions.

10. The slot machine according to claim 9, wherein
when rearranging the symbols, the controller controls a display mode of the display so that the number of columns of the targeted-symbol display regions is increased according to an increase in the bet amount.

11. The slot machine according to claim 10, wherein
the controller controls the rotating and stopping of the reel so that an increased number of symbols for a higher award according to the increase in the bet amount are displayed in the targeted-symbol display regions, by randomly determining and arranging types of symbols in every column of the targeted-symbol display regions that increase according to the increase in the bet amount.

12. The slot machine according to claim 8, wherein
the controller controls the display to show a range of the targeted-symbol display regions to a player by displaying the targeted-symbol display regions and a region other than the targeted-symbol display regions in different display modes.

13. The slot machine according to claim 11, wherein
the controller controls the display mode of the display so that a symbol for a higher award is displayed in the targeted-symbol display regions of the predetermined minimum number of columns in the case of the minimum bet amount, the symbol being to be displayed in the targeted-symbol display regions of a bet amount higher than the minimum bet amount.

14. The slot machine according to claim 11, wherein
when the bet switch receives a maximum bet amount, the controller controls the display mode of the display so that a maximum number of columns of the display regions are displayed as the targeted-symbol display regions, and that a symbol for a highest award is displayed on every column in the display regions of the maximum number of columns.

15. A method of controlling a slot machine comprising the steps of:
(a) causing a bet switch to receive a bet from a player;
(b) causing a controller to rotate a plurality of reels each including a plurality of symbols on a side surface;
(c) along with rotation of the reels, causing the controller to display an image on a display which is disposed at front face sides of the reels and includes an image display region having a symbol display region for displaying the symbols on the plurality of reels, so that a predetermined minimum number of columns within the symbol display regions are displayed as targeted-symbol display regions if the bet switch receives a minimum bet amount, the targeted-symbol display regions being targeted for counting a number of symbols of the predetermined type;
(d) causing the controller to stop the rotating reels; and
(e) causing the controller to award a winning if a predetermined number of symbols of a predetermined type are displayed in the targeted-symbol display regions.

16. The method of controlling a slot machine according to claim 15, wherein
the controller controls the display so that a location of the targeted-symbol display regions of the minimum number of columns in the case of the minimum bet amount is changed within the symbol display regions.

17. The method of controlling a slot machine according to claim 16, wherein
when rearranging the symbols, the controller controls a display mode of the display so that the number of columns of the targeted-symbol display regions is increased according to an increase in the bet amount

18. The method of controlling a slot machine according to claim 17, wherein
the controller controls the rotating and stopping the reels so that an increased number of symbols for a higher award according to the increase in the bet amount are displayed in the targeted-symbol display regions, by randomly determining and arranging types of symbols in every column of the targeted-symbol display regions that increase according to the increase in the bet amount.

19. The method of controlling a slot machine according to claim 15, wherein
the controller controls the display to show a range of the targeted-symbol display regions to a player by displaying the targeted-symbol display regions and a region other than the targeted-symbol display regions in different display modes.

20. The slot machine according to claim 18, wherein
the controller controls the display mode of the display so that a symbol for a higher award is displayed in the targeted-symbol display regions of the predetermined minimum number of columns in the case of the minimum bet amount, the symbol being to be displayed in the targeted-symbol display regions in a case of a bet amount higher than the minimum bet amount.

21. The slot machine according to claim 18, wherein
when the bet switch receives a maximum bet amount, the controller controls the display mode of the display so that a maximum number of columns of the display regions are displayed as the targeted-symbol display regions, and that a symbol for a highest award is displayed on every column in the display regions of the maximum number of columns.
